(19) United States
(12) Patent Application Publication
(10) Pub. No.: US 2010/0097352 A1
(43) Pub. Date: Apr. 22, 2010

(54) TOUCH SCREEN DISPLAY AND METHOD OF DRIVING THE SAME

(75) Inventors: Soon-Sung AHN, Yongin-City (KR); Yong-Sung Park, Yongin-City (KR); Sung-Un Park, Yongin-City (KR); Ja-Seung Ku, Yongin-City (KR)

Correspondence Address: STEIN MCEWEN, LLP, 1400 EYE STREET, NW, SUITE 300, WASHINGTON, DC, 20005, US

(73) Assignee: Samsung Mobile Display Co., Ltd., Yongin-City (KR)

(21) Appl. No.: 12/576,395

(22) Filed: Oct. 9, 2009

(30) Foreign Application Priority Data
Oct. 17, 2008 (KR) 10-2008-0102108

(51) Int. Cl. G06F 3/042

(52) U.S. Cl. 345/175; 345/76

(57) ABSTRACT

A TSD (Touch Screen Display) includes a panel including a plurality of light emitting devices to form an image, and a plurality of photo sensors to capture an image of an object touching the panel; a touch position deriving unit to derive a touch position of the object based on output signals of the photo sensors; and a light emission control unit to derive a probability of a plurality of previous touch positions derived by the touch position deriving unit, predict a next touch position after the plurality of previous touch positions according to the probability, and control at least one of the light emitting devices in a light emission area including the next touch position to emit light.

### CROSS-REFERENCE TO RELATED PATENT APPLICATIONS

This application claims the benefit of Korean Patent Application No. 2008-0102108 filed on Oct. 17, 2008, in the Korean Intellectual Property Office, the disclosure of which is incorporated herein by reference in its entirety.

### BACKGROUND OF THE INVENTION

1. Field of the Invention

Aspects of the invention relate to a touch screen display (TSD) including a light emitting device and a photo sensor, and a method of driving the TSD.

2. Description of the Related Art

A touch screen display (TSD) having a photo sensor-integrated panel detects light from a projected image of a touch object on a screen to perform an information input. Also, a TSD may detect light emitted from a light emitting object such as a light pen and the like to perform an information input.

More specifically, the TSD may derive a touch position by using external light or by using internal light that is emitted to form an image on the TSD. However, when the external light and the internal light are weak, for example, when a black user interface (UI) is displayed under poor external light conditions, a photo sensor may not sense the light properly. Thus, when a condition with respect to the external light or the internal light is inappropriate, usage of the TSD may be limited by the condition.

### SUMMARY OF THE INVENTION

Aspects of the invention relate to a touch screen display (TSD) and a method of driving the TSD, whereby a touch position may be effectively detected using photo sensors when external and internal light conditions are inappropriate while minimizing alteration of an image displayed on the TSD.

According to an aspect of the invention, a TSD (Touch Screen Display) includes a panel including a plurality of light emitting devices to form an image, and a plurality of photo sensors to capture an image of an object touching the panel; a touch position deriving unit to derive a touch position of the object based on output signals of the photo sensors; and a light emission control unit to derive a probability of a plurality of previous touch positions derived by the touch position deriving unit, predict a next touch position after the plurality of previous touch positions according to the probability, and control at least one of the light emitting device devices in a light emission area including the next touch position to emit light.

According to an aspect of the invention, the light emission control unit includes a touch position probability deriving unit to derive the probability of the plurality of previous touch positions derived by the touch position deriving unit; a light emission determining unit to predict the next touch position after the plurality of previous touch positions according to the probability; and determine the light emission area including the next touch position; and a light emission control signal generating unit to generate a light emission control signal to control the at least one of the light emitting devices in the light emission area to emit light.

According to an aspect of the invention, the touch position deriving unit derives a current touch position based on output signals of the photo sensors while the light is being emitted from the at least one of the light emitting devices in the light emission area.

According to an aspect of the invention, the TSD further includes a touch sensing unit to sense a touch of the object on the panel.

According to an aspect of the invention, the light emission control unit includes a first light emission control signal generating unit to generate a first light emission control signal to control at least some of the light emitting devices to emit light when the touch sensing unit senses the touch of the object on the panel.

According to an aspect of the invention, the touch position deriving unit drives the plurality of previous touch positions based on output signals of the photo sensors while the light is being emitted from the at least some of the light emitting devices under the control of the first light emission control signal.

According to an aspect of the invention, the light emission control unit further includes a touch position probability deriving unit to derive the probability of the plurality of previous touch positions; a light emission area determining unit to predict the next touch position according to the probability, and determine the light emission area including the next touch position; and a second light emission control signal generating unit to generate a second light emission control signal to control the at least one of the light emitting devices in the light emission area to emit light.

According to an aspect of the invention, the at least some of the light emitting devices that are controlled to emit light when the touch sensing unit senses the touch on the panel are random ones of the light emitting devices of the panel.

According to an aspect of the invention, the at least some of the light emitting devices that are controlled to emit light when the touch sensing unit senses the touch on the panel are all of the light emitting devices of the panel.

According to an aspect of the invention, the probability corresponds to a rectilinear correlation in which the plurality of previous touch positions continuously occur in a direction; and the next touch position predicted according to the probability is a touch position adjacent to a last one of the plurality of previous touch positions in the direction.

According to an aspect of the invention, the probability corresponds to a trace along which the plurality of previous touch positions continuously rotate in a direction, or rotate by a predetermined rotation angle; and the next touch position predicted according to the probability is a touch position that is adjacent to a last one of the plurality of previous touch positions in the direction, or that is separated from the last one of the plurality of previous touch positions by the predetermined rotation angle.

According to an aspect of the invention, the probability corresponds to a correlation in which a touch position for forming a vowel comes after a plurality of touch positions for forming consonants; and when the plurality of previous touch positions are touch positions for forming consonants, the next touch position predicted according to the probability is a touch position for forming a vowel.

According to an aspect of the invention, there is provided a method of driving a TSD (Touch Screen Display) including a panel including a plurality of light emitting devices to form an image, and a plurality of photo sensors to capture an image of an object touching the panel, the method including deriving a probability of a plurality of previous touch positions of the object touching the panel based on output signals of the photo sensors; determining a light emission area including a next touch position after the plurality of previous touch positions predicted according to the probability; generating a light emission control signal to control at least one of the light emitting devices in the light emission area to emit light; controlling the at least one light of the emitting devices in the light emission area to emit light in response to the light emission control signal; capturing an image of the object touching panel based on output signals of the photo sensors while the light is being emitted from the at least one of the light emitting devices in the light emission area; and deriving a current touch position based on the image of the object captured while the light is being emitted from the at least one of the light emitting devices in the light emission area.

Additional aspects and/or advantages of the invention will be set forth in part in the description that follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIG. 1 is a block diagram of a touch screen display (TSD) according to an aspect of the invention;

FIG. 2 is a block diagram of a light emission control unit of the TSD in FIG. 1; FIG. 3 is a cross-sectional view of the TSD of FIG. 1 showing an input method of the

TSD;

FIGS. 4A and 4B show touch input methods of the TSD of FIG. 1;

FIGS. 5 through 7 show probability patterns of touch positions on the TSD of FIG. 1;

FIG. 8 is a flowchart of a method of driving the TSD of FIG. 1 according to an aspect of the invention;

FIG. 9 is a block diagram of a TSD according to an aspect of the invention;

FIG. 10 is a block diagram of a light emission control unit of the TSD in FIG. 9;

FIG. 11 is a flowchart of a method of driving the TSD of FIG. 9 according to an aspect of the invention; and

FIGS. 12A through 12C are cross-sectional views of the TSD of FIG. 9 showing an input method of the TSD.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below in order to explain the invention by referring to the figures.

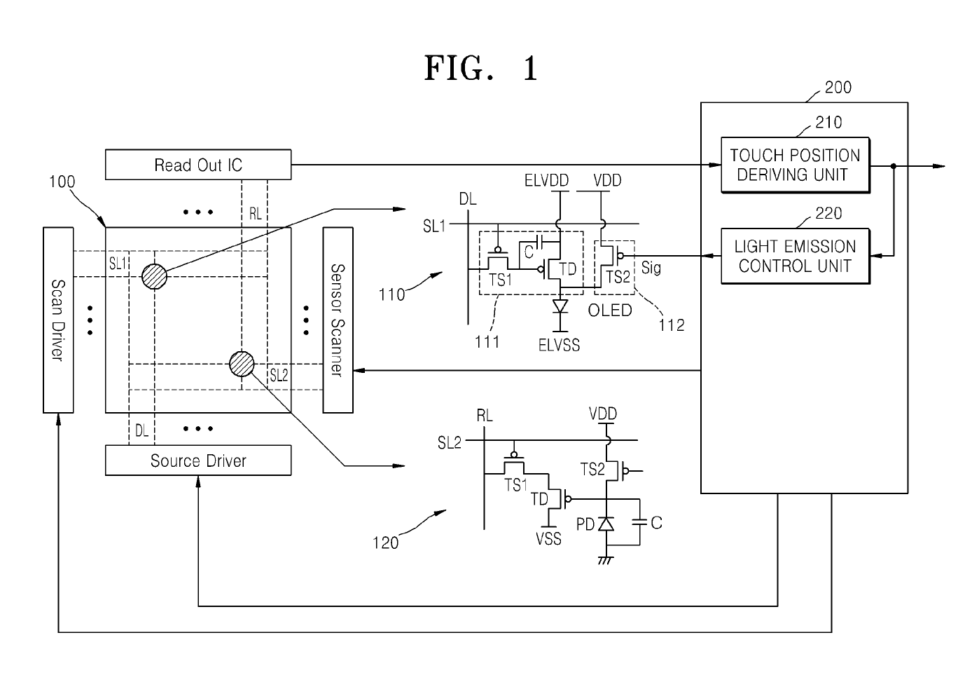

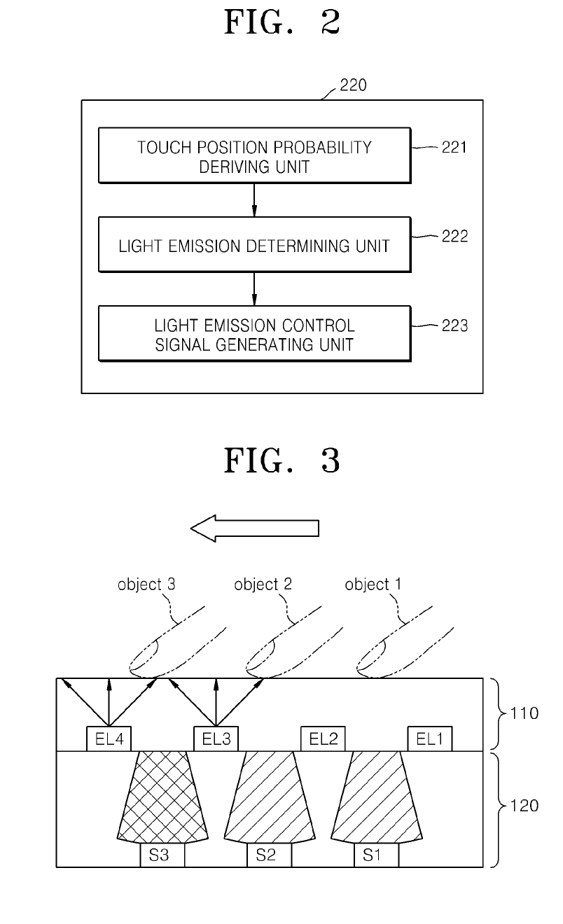

FIG. 1 is a block diagram of a touch screen display (TSD) according to an aspect of the invention. FIG. 2 is a block diagram of a light emission control unit 220 of the TSD in FIG. 1. Referring to FIG. 1, the TSD includes a panel 100, driving units for driving the panel 100, and a control unit 200.

The panel 100 includes a plurality of pixel units 110 and a plurality of sensor units 120. The pixel unit 110 includes a light emitting device, such an organic light emitting diode (OLED), and the sensor unit 120 includes a photo sensor PD that captures an image of a touch object.

The pixel unit 110 includes a data line DL delivering display data, and a first scan line SL1 crossing the data line DL and transmitting a scan signal. The data line DL is connected to a source driver to receive the display data. A scan driver applies the scan signal to the first scan line SL1. The display data and the scan signal are provided by the control unit 200.

The pixel unit 110 includes a pixel circuit unit 111 connected between the data line DL and the first scan line SL1, and a switching circuit unit 112 connected to a light emission control line. Also, the pixel unit 110 includes the OLED connected to the pixel circuit unit 111 and the switching circuit unit 112.

The pixel circuit unit 111 is turned on by the scan signal of the first scan line SL1, and includes a first transistor TS1 that transmits the display data delivered from the data line DL. The display data transmitted via the first transistor TS1 is input to a gate terminal of a driving transistor TD. Also, a first driving voltage ELVDD is applied to a terminal of the driving transistor TD. The pixel circuit unit further includes a capacitor C between the terminal and the gate terminal of the driving transistor TD. The capacitor C maintains a voltage difference between the first driving voltage ELVDD and the voltage corresponding to the display data during a predetermined time period. A cathode terminal of the OLED is connected to the other terminal of the driving transistor TD. A second driving voltage ELVSS is applied to an anode terminal of the OLED. A current with respect to the display data may be output via the other terminal of the driving transistor TD, and the OLED may emit light in correspondence to the current. In FIG. 1, the pixel circuit unit 111 is a basic pixel circuit based on a voltage driving but the invention is not limited thereto, and the pixel circuit unit 111 can be a basic pixel circuit based on a current driving method, and can include a plurality of transistors for compensating for a threshold voltage of the driving transistor TD.

The switching circuit unit 112 includes a second transistor TS2 having a gate terminal connected to the light emission control line, a terminal receiving a driving voltage VDD, and another terminal connected to the cathode of the OLED. When a control signal is transmitted via the light emission control line, the second transistor TS2 is turned on to output a predetermined current from the other terminal. The predetermined current is output to the OLED, thereby enabling the OLED to emit light with a predetermined brightness. The light emission of the OLED may be controlled with Display Drive Integrated Circuit (DDI) driving, instead of using the second transistor TS2. Also, the first driving voltage ELVDD of the first transistor TS1 and the driving voltage VDD of the second transistor TS2 may be the same, which will prevent a reverse current flowing backward from the OLED to the driving transistor TD. However, when the first driving voltage ELVDD of the first transistor TS1 is different from the driving voltage VDD of the second transistor TS2, another transistor may be connected between the OLED and the driving transistor TD to prevent a reverse current from flowing backward from the OLED to the driving transistor TD. That is, when the second transistor TS2 is turned on, the other transistor is turned off to prevent the reverse current from flowing backward from the OLED to the driving transistor TD.

The light emission control line is connected to the control unit 200, and generates and transmits a light emission control signal Sig delivered via the light emission control line as will be described later.

The pixel circuit unit 111 and the switching circuit unit 112 are commonly connected to the OLED. The pixel circuit unit 111 provides the current with respect to the display data to the OLED, thereby allowing the OLED to emit light to form a particular image. Also, the switching circuit unit 112 allows the OLED to emit light according to the light emission control signal Sig provided from the control unit 200. In this case, the OLED emits the light not to form a specific image, but to generate a predetermined internal light that is necessary for the photo sensor PD to capture an image of a touch object. When an external light and an internal light of the TSD are weak, the predetermined internal light is emitted to allow the photo sensor PD to capture the image of the touch object so that a touch position of the touch object can be derived.

The sensor unit 120 includes a second scan line SL2 and an output line RL crossing the second scan line SL2. The second scan line SL2 is connected to a sensor scanner to receive a scan signal. The output line RL is connected to a Read Out IC (ROIC). The ROIC collects sensing signals provided from the output line RL, and transmits the sensing signals to the control unit 200. The control unit 200 derives the touch position of the touch object according to the sensing signals.

Also, the sensor unit 120 includes the photo sensor PD that receives a light signal and transforms the light signal to an electric signal. The photo sensor PD is a photodiode, and a gate terminal of a driving transistor TD is connected to an anode terminal of the photodiode, and an anode terminal of the photodiode is connected to a ground voltage. However, the invention is not limited to a photodiode, and any suitable photo sensor may be used. A capacitor Also, the gate terminal of the driving transistor TD is connected to a second transistor TS2 that is turned on by a reset signal to deliver a first driving voltage VDD. A second driving voltage VSS is applied to a terminal of the driving transistor TD. The photo sensor PD receives light, which causes a current to flow from the anode terminal of the photo sensor PD to a cathode terminal of the photo sensor PD, thereby decreasing a voltage applied to the gate terminal of the driving transistor TD. Another terminal of the driving transistor TD outputs a current to the output line RL via a first transistor TS1, wherein the current is determined by the voltage at the gate terminal of the driving transistor TD that is changed due to the current flowing in the photo sensor PD and the second driving voltage VSS applied to the terminal of the driving transistor TD. A capacitor C is connected to the anode terminal of the photo sensor PD and the cathode terminal of the photo sensor PD to maintain a voltage difference between the voltage of the anode terminal and the voltage of the cathode terminal, which is also the voltage applied to the gate terminal of the driving transistor TD. In order to output the current to the output line RL, the first transistor TS1 has to be turned on by receiving the scan signal from the second scan line SL2.

The photo sensor PD may receive light emitted from the OLED, thereby generating the electric signal. In particular, when the external light and the internal light of the TSD are weak, the OLED is forced to emit light according to the light emission control signal Sig so that the light from the OLED may be sensed by the photo sensor PD to enable the sensor circuit 120 output a sensing signal via the output line RL.

The sensing signal output via the output line RL is collected by the ROIC that outputs the sensing signal to a touch position deriving unit 210 of the control unit 200. The touch position deriving unit 210 derives the touch position based on the sensing signal. The touch position deriving unit 210 analyzes an image of the touch object via the sensing signal, and derives the touch position from the image. Information about the derived touch position is output to a host, and is also transmitted to the light emission control unit 220.

Referring to FIG. 2, the light emission control unit 220 will now be described in detail. The light emission control unit 220 includes a touch position probability deriving unit 221, a light emission determining unit 222, and a light emission control signal generating unit 223.

The touch position probability deriving unit 221 derives probability of a plurality of touch positions. For example, when previous touch positions have a rectilinear correlation in which the previous touch positions continuously occur in a direction, the probability of touch positions corresponds to the rectilinear correlation. Thus, a next touch position according to the probability of touch positions may be a touch position that is adjacent to a last previous touch position among the previous touch positions in the direction. Also, the previous touch positions may have a trace along which the previous touch positions continuously rotate in a direction or rotate by a specific rotation angle, and in this case, the next touch position according to the probability of touch positions may be a touch position that is adjacent to the last previous touch position in the direction or that is separated from the last previous touch position by the specific rotation angle. Also, according to the probability of touch positions, touch positions for forming vowels may come after touch positions for forming consonants. That is, when the previous touch positions form consonants, the next touch position according to the probability of touch positions may be a touch position that forms a vowel. The probability of touch positions may be previously stored according to experience data, or a new probability may be derived by referring to touch positions being continuously input, and the current probability may be updated to the new probability. That is, the touch position probability deriving unit 221 derives the probability of previous touch positions provided from the touch position deriving unit 210.

According to the probability derived by the touch position probability deriving unit 221, the next touch position after the previous touch positions may be predicted. The light emission determining unit 222 may predict the next touch position and may determine a light emission area including the next touch position. The next touch position is a position on the panel 100 that is predicted to be touched by a user after the previous touch positions, and the prediction is based on the probability. The light emission area may be the next touch position or may be a local panel area including the next touch position.

The light emission control signal generating unit 223 generates the light emission control signal Sig that controls the OLED of the light emission area to emit light. The light emission control signal Sig turns on the second transistor TS2 of the switching circuit unit 112. The second transistor TS2 provides a current with respect to the driving voltage VDD to the OLED. Thus, the OLED emits light having an intensity corresponding to the current. The OLED emitting the light in this manner is disposed in the light emission area determined by the light emission determining unit 222. The panel 100 includes a plurality of pixel units 110, and a plurality of sensor units 120 disposed between the plurality of pixel units 110. The light emission control signal forces only the OLED in the light emission area to emit light during a predetermined time period, wherein the OLED is included in at least one pixel unit 110 of the light emission area among the plurality of pixel units 110. If the light emission control signal Sig is not applied, the OLED disposed in the light emission area emits light to form the image corresponding to the display data, and OLEDs disposed in areas of the panel 100 other than the light emission area constantly emit light to form the image corresponding to the display data. That is, a forcible light emission is not performed in the OLEDs disposed in the areas of the panel 100 other than the light emission area.

FIG. 3 is a cross-sectional view of the TSD of FIG. 1 showing an input method of the TSD. Referring to FIG. 3, the pixel unit 110 and the sensor unit 120 are integrated to form the TSD. A plurality of OLEDs EL1 through EL4 of the pixel unit 110 are disposed in the TSD with a predetermined distance between the plurality of OLEDs EL1 through EL4. A plurality of photo sensors S1 through S3 of the sensor unit 120 may be disposed between the OLEDs EL1 through EL4. The photo sensors S1 through S3 and the OLEDs EL1 through EL4 may be disposed not to block each other, so that a light input and light emission may be effectively performed.

An operation of the TSD will be described with reference to FIG. 3. An object sequentially touches a first touch position (object 1) and a second touch position (object 2), so that a probability of the first and second touch positions (objects 1 and 2); that is, the previous touch positions, is derived. For example, if it is determined that the first touch position (object 1) and the second touch position (object 2) occur in a direction (refer to a direction indicated by the arrow ‘←’ in FIG. 3), and thus mutually have a rectilinear correlation, it is possible to predict that a next touch position of the previous touch positions may be at a position on a line extended from the second touch position (object 2) in the direction (the ‘←’ direction). That is, it is possible to predict that the next touch position may be a third touch position (object 3) separated from the second touch position (object 2) in the direction by a distance corresponding to a distance between the first touch position (object 1) and the second touch position (object 2). After that, a light emission area including the next touch position is determined, and the OLEDs EL3 and EL4 of the light emission area emit light. Even if an external light and an internal light of the TSD are weak, a position touched by a current object, that is, a current touch position (object 3), may be derived via the light emission of the OLEDs EL3 and EL4. An image of the current object at the current touch position (object 3) is captured by the photo sensor S3, and the current touch position (object 3) is derived from the image of the current object.

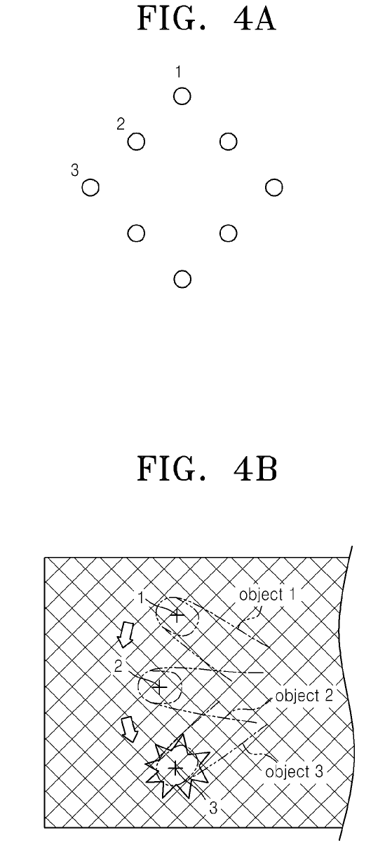

FIGS. 4A and 4B show touch input methods of the TSD of FIG. 1. FIG. 4A shows a pre-stored probability in which an object touches in a counter-clockwise direction (1→2→3) with a predetermined rotation angle. Referring to FIG. 4B, an object touches a first touch position (object 1) and a second touch position (object 2). A probability similar to that described with reference to FIG. 4A is derived from the first touch position (object 1) and the second touch position (object 2). A next touch position is predicted according to the probability, and a light emission area including the next touch position emits light. According to the light emission, a current touch position (object 3) is derived.

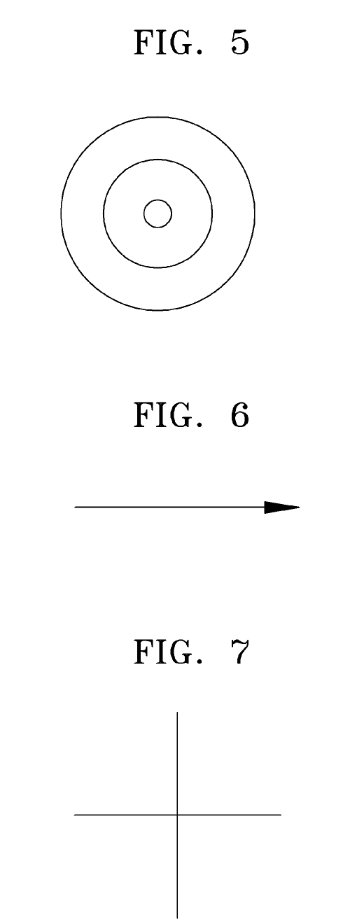

FIGS. 5 through 7 show probability patterns of touch positions on the TSD of FIG. 1. FIG. 5 corresponds to a circle pattern probability, FIG. 6 corresponds to a rectilinear pattern probability of touch positions occurring in a direction, and FIG. 7 corresponds to a cross pattern probability. Information about the various probability patterns may be previously stored. Also, information about probabilities having other various shapes and patterns may also be previously stored. In addition, although not shown in FIGS. 5 through 7, a probability with respect to a text input may also be previously stored, wherein a touch corresponding to a consonant is performed and then a touch corresponding to a vowel is performed according to the probability with respect to the text input. Thus, if it is determined that consonants are input from previous touch positions, a next touch position corresponding to a vowel may be predicted, and a light emission area including the next touch position may locally emit light.

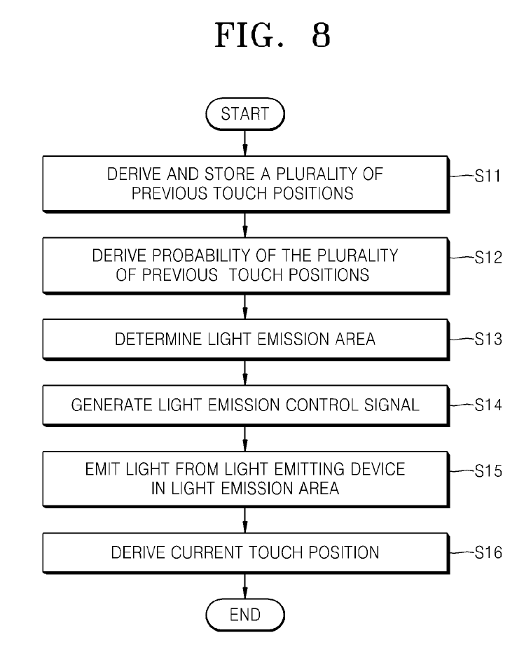

FIG. 8 is a flowchart of a method of driving the TSD of FIG. 1 according to an aspect of the invention. Referring to FIG. 8, a plurality of previous touch positions are derived and stored (operation S11). A probability of the previous touch positions is derived (operation S12). The previous touch positions may be determined to correspond to at least one of a pre-stored symbol, a shape, and a text, and thus the probability based on at least one of the symbol, the shape, and the text may be derived. The probability may relate to an input method of a digital electronic device, such as a double-click, a drag, and the like.

According to the probability, a next touch position after the previous touch positions is predicted, and a light emission area including the next touch position is determined (operation S13). The light emission area may be the next touch position, or may be a local panel area including the next touch position. A light emission control signal is generated to allow a light emitting device, in particular, an OLED, included in the light emission area to emit light (operation S14). The OLED in the local panel area emits the light by receiving the light emission control signal (operation S15). An image of an object currently touching the TSD is captured according to the light emission, and a current touch position of the object is derived from the image (operation S16).

Thus, when an external light and an internal light of the TSD are weak, the current touch position of the object may be derived without significantly altering the image corresponding to display data that is currently being input. In other words, when a black UI is displayed on the screen of the TSD under weak external light conditions, only the local panel area including the next touch position emits light so that the current touch position of the object may be derived by using the light emission of the local panel area, without significantly altering the black UI displayed on the screen of the TSD.

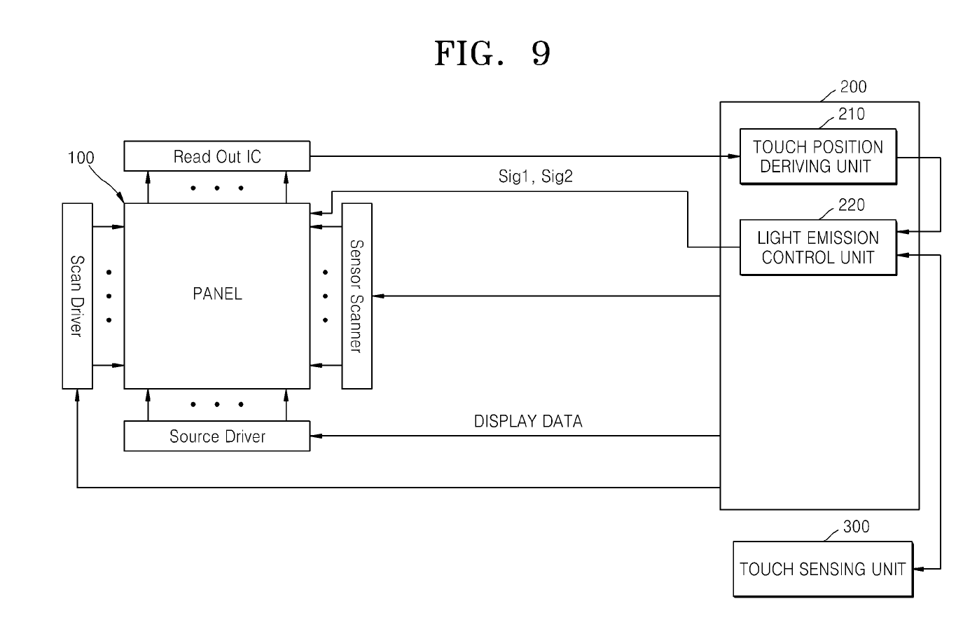

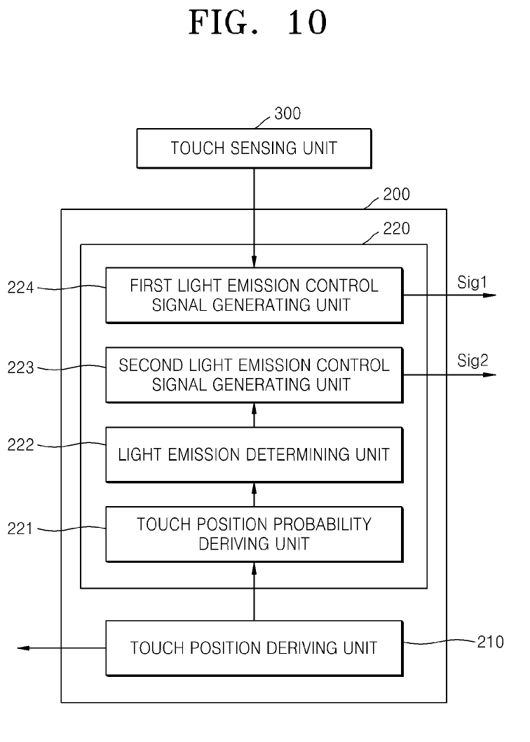

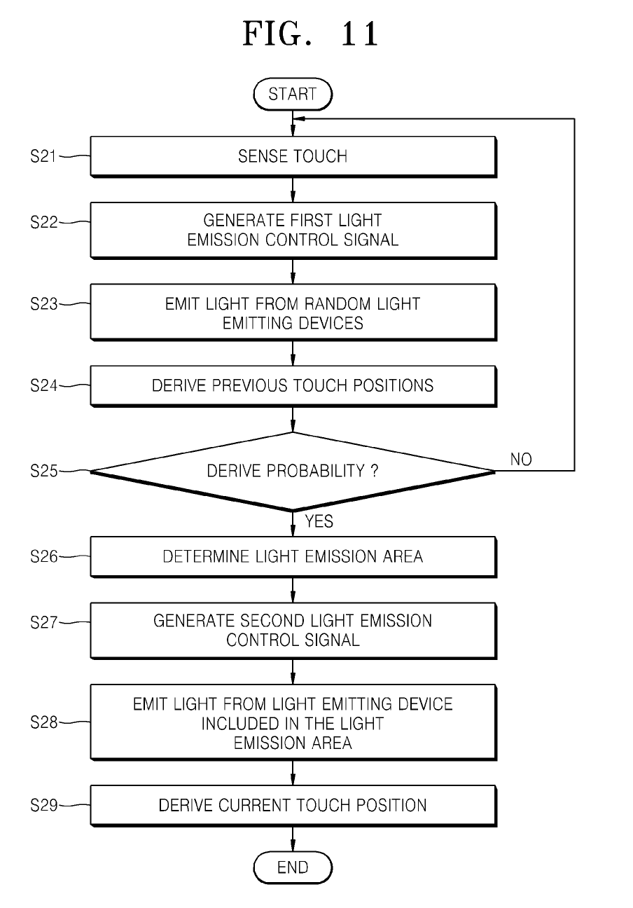

FIG. 9 is a block diagram of a TSD according to an aspect of the invention. FIG. 10 is a block diagram of a light emission control unit 220 of the TSD in FIG. 9. Referring to FIG. 9, the TSD includes a panel 100, driving units for driving the panel 100, a control unit 200, and a touch sensing unit 300. The panel 100 and the driving units are same as those of FIG. 1, and thus their detailed descriptions will be omitted here.

In comparison to the TSD of FIG. 1, the TSD of FIG. 9 further includes the touch sensing unit 300, which is a touch panel enabled to sense a touch using electrostatic capacity technology, or reduced pressure technology, or resistive film technology, or any other touch sensing technology compatible with the panel 100. The touch sensing unit 300 is disposed on an entire surface of the panel 100, thereby sensing a touch by an object. Since the touch sensing unit 300 is disposed on the entire surface of the panel 100, the touch sensing unit 300 may be formed of a transparent material having a high optical transmittance. When the touch sensing unit 300 senses a touch, the touch sensing unit 300 transmits a control signal corresponding to the sensed touch to the light emission control unit 220.

Referring to FIG. 10, the touch sensing unit 300 transmits the control signal corresponding to the sensed touch to a first light emission control signal generating unit 224. The first light emission control signal generating unit 224 generates a first light emission control signal Sig1 that allows random OLEDs of the panel 100 to emit light, or all OLEDs of the panel 100 to emit light.

When the conditions of an internal light and an external light of the TSD are inappropriate for sensing a touch, a touch is sensed by the touch sensing unit 300, and when the touch is sensed, random OLEDs of the panel 100 are forced to emit light during a predetermined time period to derive a touch position. Examples of conditions with weak internal light and external light include a case when a touch position cannot be derived, a case when an internal light is dim since a black UI is displayed on a screen under weak external light conditions, and a case when an object image formed by an external light is counterbalanced by a reflection light of an internal light since the external light and the internal light are similar to each other so that the object image cannot be detected.

A plurality of touch positions are derived by a touch position deriving unit 210 by forcing the random OLEDs of the panel 100 to emit light during the predetermined time period. When the touch position deriving unit 210 derives the previous touch positions, a touch position probability deriving unit 221 derives a probability from the previous touch positions. A light emission determining unit 222 predicts a next touch position after the previous touch positions according to the probability, and determines a light emission area including the predicted next touch position. Then, a second light emission control signal generating unit 223 generates a second light emission control signal Sig2 that controls an OLED included in the light emission area to emit light. The first light emission control signal Sig1 controls the random OLEDs to emit light, and the second light emission control signal Sig2 controls the OLED in the light emission area including the predicted next touch position to emit light. The OLED in the light emission area emits light due to the second light emission control signal Sig2, an image of the object is captured by a photo sensor in the light emission area due to the light emission, and the image is analyzed by the touch position deriving unit 210 to derive a current touch position of the object.

FIG. 11 is a flowchart of a method of driving the TSD of FIG. 9 according to an aspect of the invention. Referring to FIG. 11, a touch of an object on a panel is sensed (operation S21). When the touch is sensed, a first light emission control signal is generated (operation S22). A plurality of random light emitting devices of the panel, in particular, random OLEDs, emit light according to the first light emission control signal during a predetermined time period (operation S23). Alternatively, OLEDs of the entire panel may emit light during the predetermined time period. A plurality of previous touch positions are derived based on the light emission in operation S23 (operation S24). The touch positions derived in operation S24 are referred to as “previous touch positions” to discriminate them from a touch position to be described below. Whether it is possible to derive a probability from the previous touch positions is determined (operation S25). If the probability is not derived, the method returns to operation S21. Otherwise, if the probability is derived, a next touch position after the previous touch positions is predicted according to the probability, and a light emission area including the next touch position is determined (operation S26). A second light emission control signal is generated to allow an OLED included in the light emission area to emit light (operation S27). The second light emission control signal is transmitted to the panel, and thus the OLED included in the light emission area is controlled to emit light (operation S28). A current touch position of the object is derived based the light emission in operation S28 (operation S29).

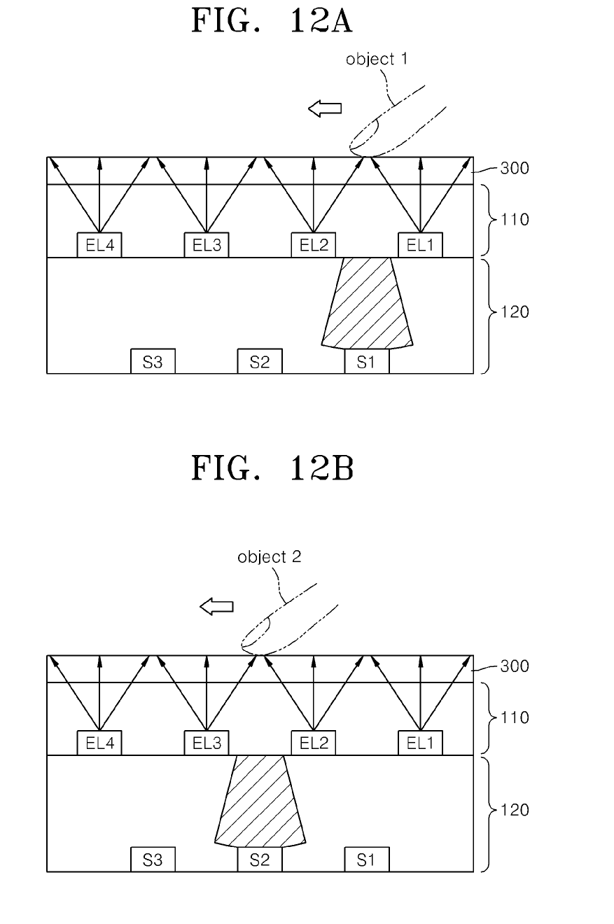

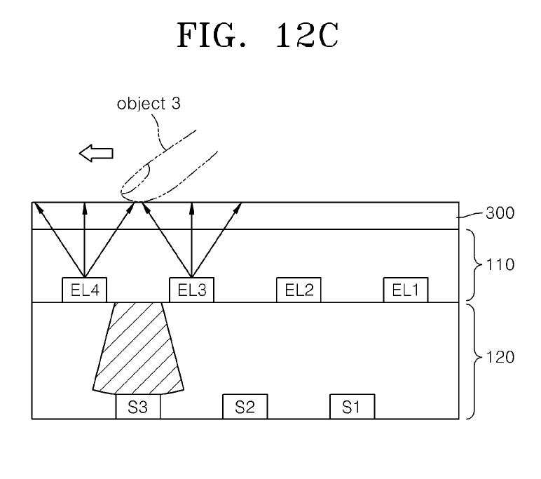

FIGS. 12A through 12C are cross-sectional views of the TSD of FIG. 9 showing an input method of the TSD. The TSD of FIG. 9 has a structure in which the touch sensing unit 300 is disposed on a front side of the panel 100, and the pixel units 110 and the sensor units 120 are integrally formed in the panel 100.

Referring to FIG. 12A, when an object touches the touch sensing unit 300 at a first touch position (object 1), the touch sensing unit 300 senses the touch and thus allows random OLEDs EL1 through EL4 to emit light. This enables an image of the object 1 to be captured by a first photo sensor 51, and the first touch position (object 1) of the object is derived from the image. After that, whether a probability is derived from the first touch position (object 1) is determined. If the probability is not derived, referring to FIG. 12B, the touch sensing unit 300 senses that the object touches the touch sensing unit 300 at a second touch position (object 2). The touch sensing unit 300 then forces the random OLEDs EL1 through EL4 to emit light. Accordingly, an image of the object is captured by a second photo sensor S2, and a second touch position (object 2) of the object is derived from the image.

A probability is derived from the first touch position (object 1) and the second touch position (object 2), which are previous touch positions. If the previous touch positions have a rectilinear probability in which the previous touch positions are directed along a line to the left, a next touch position may be predicted to be at a position that is separated from the second touch position (object 2) by a predetermined distance in to the left. Thus, as shown in FIG. 12C, OLEDs EL3 and EL4 of a light emission area including the next touch position are forced to emit light. Based on the light emission of the OLEDs EL3 and EL4, an image of an object 3 is captured by a third photo sensor S3, and a third touch position (object 3) as a current touch position is derived from the image.

Accordingly, according to aspects of the invention, it is possible to effectively recognize a touch position with a photo sensor when an external light and an internal light of a TSD are weak while minimizing alteration of an image to be displayed on the TSD.

According to aspects of the invention, a probability may be derived from previous touch positions, and only a light emitting device of a local light emission area including a next touch position predicted according to the probability may be allowed to emit light, so that a TSD and a method of driving the TSD may effectively recognize a current touch position by using the photo sensor while minimizing alteration of an image corresponding to display data displayed on the TSD.

Although several embodiments of the invention have been shown and described, it would be appreciated by those skilled in the art that various changes may be made in these embodiments without departing from the principles and spirit of the invention, the scope of which is defined in the claims and their equivalents.

What is claimed is:

1. A TSD (Touch Screen Display) comprising:
a panel comprising a plurality of light emitting devices to form an image, and a plurality of photo sensors to capture an image of an object touching the panel;
a touch position deriving unit to derive a touch position of the object based on output signals of the photo sensors; and
a light emission control unit to derive a probability of a plurality of previous touch positions derived by the touch position deriving unit, predict a next touch position after the plurality of previous touch positions according to the probability, and control at least one of the light emitting devices in a light emission area comprising the next touch position to emit light.

2. The TSD of claim 1, wherein the light emission control unit comprises:
a touch position probability deriving unit to derive the probability of the plurality of previous touch positions derived by the touch position deriving unit;
a light emission determining unit to predict the next touch position after the plurality of previous touch positions according to the probability, and determine the light emission area comprising the next touch position; and
a light emission control signal generating unit to generate a light emission control signal to control the at least one of the light emitting devices in the light emission area to emit light.

3. The TSD of claim 2, wherein the touch position deriving unit derives a current touch position based on output signals of the photo sensors while the light is being emitted from the at least one of the light emitting devices in the light emission area.

4. The TSD of claim 1, further comprising a touch sensing unit to sense a touch of the object on the panel.

5. The TSD of claim 4, wherein the light emission control unit comprises a first light emission control signal generating unit to generate a first light emission control signal to control at least some of the light emitting devices to emit light when the touch sensing unit senses the touch of the object on the panel.

6. The TSD of claim 5, wherein the touch position deriving unit derives the plurality of previous touch positions based on output signals of the photo sensors while the light is being emitted from the at least some of the light emitting devices under the control of the first light emission control signal.

7. The TSD of claim 6, wherein the light emission control unit further comprises:
a touch position probability deriving unit to derive the probability of the plurality of previous touch positions;
a light emission area determining unit to predict the next touch position after the plurality of previous touch positions according to the probability, and determine the light emission area comprising the next touch position; and
a second light emission control signal generating unit to generate a second light emission control signal to control the at least one of the light emitting devices in the light emission area to emit light.

8. The TSD of claim 5, wherein the at least some of the light emitting devices that are controlled to emit light when the touch sensing unit senses the touch on the panel are random ones of the light emitting devices of the panel.

9. The TSD of claim 5, wherein the at least some of the light emitting devices that are controlled to emit light when the touch sensing unit senses the touch on the panel are all of the light emitting devices of the panel.

10. The TSD of claim 1, wherein:
the probability corresponds to a rectilinear correlation in which the plurality of previous touch positions continuously occur in a direction; and
the next touch position predicted according to the probability is a touch position adjacent to a last one of the plurality of previous touch positions in the direction.

11. The TSD of claim 1, wherein:
the probability corresponds to a trace along which the plurality of previous touch positions continuously rotate in a direction, or rotate by a predetermined rotation angle; and
the next touch position predicted according to the probability is a touch position that is adjacent to a last one of the plurality of previous touch positions in the direction, or that is separated from the last one of the plurality of previous touch positions by the predetermined rotation angle.

12. The TSD of claim 1, wherein:
the probability corresponds to a correlation in which a touch position for forming a vowel comes after a plurality of touch positions for forming consonants; and
when the plurality of previous touch positions are touch positions for forming consonants, the next touch position predicted according to the probability is a touch position for forming a vowel.

13. A method of driving a TSD (Touch Screen Display) comprising a panel comprising a plurality of light emitting devices to form an image, and a plurality of photo sensors to capture an image of an object touching the panel, the method comprising:
deriving a probability of a plurality of previous touch positions of the object touching the panel based on output signals of the photo sensors;
determining a light emission area comprising a next touch position after the plurality of previous touch positions predicted according to the probability;
generating a light emission control signal to control at least one of the light emitting devices in the light emission area to emit light;
controlling the at least one of the light emitting devices in the light emission area to emit light in response to the light emission control signal;
capturing an image of the object touching the panel based on output signals of the photo sensors while the light is being emitted from the at least one of the light emitting devices in the light emission area; and
deriving a current touch position based on the image of the object captured while the light is being emitted from the at least one of the light emitting devices in the light emission area.

14. The method of claim 13, wherein:
the probability corresponds to a rectilinear correlation in which the plurality of previous touch positions continuously occur in a direction; and
the next touch position predicted according to the probability is a touch position adjacent to a last one of the plurality of previous touch positions in the direction.

15. The method of claim 13, wherein:
the probability corresponds to a trace along which the plurality of previous touch positions continuously rotate in a direction, or rotate by a predetermined rotation angle; and
the next touch position predicted according to the probability is a touch position that is adjacent to a last one of the plurality of previous touch positions in the direction, or that is separated from the last one of the plurality of previous touch positions by the predetermined rotation angle.

16. The method of claim 13, wherein:
the probability corresponds to a correlation in which a touch position for forming a vowel comes after a plurality of touch positions for forming consonants; and
when the plurality of previous touch positions are touch positions for forming consonants, the next touch position predicted according to the probability is a touch position for forming a vowel.

17. A method of driving a TSD (Touch Screen Display) comprising a panel comprising a plurality of light emitting devices to form an image, and a plurality of photo sensors to capture an image of an object touching the panel, the TSD further comprising a touch sensing unit to sense a touch of the object on the panel, the method comprising:
sensing a touch of the object on the panel using the touch sensing unit;
generating a first light emission control signal when the touch sensing unit senses the touch of the object on the panel;
controlling at least some of the light emitting devices to emit light in response to the first light emission control signal;
deriving a plurality of previous touch positions based on output signals of the photo sensors while the at least some of the light emitting devices are emitting light under the control of the first light emission control signal;
deriving a probability of the plurality of previous touch positions;
determining a light emission area comprising a next touch position after the plurality of previous touch positions predicted according to the probability;
generating a second light emission control signal to control at least one of light emitting devices in the light emission area to emit light;
controlling the at least one of the light emitting devices in the light emission area to emit light in response to the second light emission control signal; and
capturing an image of the object touching the panel based on output signals of the photo sensors while the light is being emitted from the at least one of the light emitting devices in the light emission area; and
deriving a current touch position based on the image of the object captured while the light is being emitted from the at least one of the light emitting devices in the light emission area.

18. The method of claim 17, wherein:
the probability corresponds to a rectilinear correlation in which the plurality of previous touch positions continuously occur in a direction; and
the next touch position predicted according to the probability is a touch position adjacent to a last one of the plurality of previous touch positions in the direction.

19. The method of claim 15, wherein:
the probability corresponds to a trace along which the plurality of previous touch positions continuously rotate in a direction, or rotate by a predetermined rotation angle; and
the next touch position predicted according to the probability is a touch position that is adjacent to a last one of the plurality of previous touch positions in the direction, or that is separated from the last one of the plurality of previous touch positions by the predetermined rotation angle.

20. The method of claim 17, wherein:
the probability corresponds to a correlation which a touch position for forming a vowel comes after a plurality of touch positions for forming consonants; and
when the plurality of previous touch positions are touch positions for forming consonants, the next touch position predicted according to the probability is a touch position for forming a vowel.
